(19) United States
(12) Patent Application Publication
(10) Pub. No.: US 2013/0226892 A1
(43) Pub. Date: Aug. 29, 2013

(54) MULTIMODAL NATURAL LANGUAGE INTERFACE FOR FACETED SEARCH

(71) Applicant: Fluential, LLC, (US)

(72) Inventors: Farzad Ehsani, Sunnyvale, CA (US); Silke Maren Witt-Ehsani, Sunnyvale, CA (US)

(73) Assignee: Fluential, LLC, Sunnyvale, CA (US)

(21) Appl. No.: 13/781,524

(22) Filed: Feb. 28, 2013

Related U.S. Application Data
(60) Provisional application No. 61/604,746, filed on Feb. 29, 2012.
(60) Provisional application No. 61/711,101, filed on Oct. 8, 2012.

(51) Int. Cl. G06F 17/30

(52) U.S. Cl. CPC G06F 17/30864
USPC 707/706

(57) ABSTRACT

Search interfaces, systems, and methods are presented. Contemplated search interfaces allow electronic devices to capture multi-modal interaction data, including audio signals. A dialog interface capable of interacting with a user processes the interaction data and communicates with a user to establish a desirable query interpretation. Further, the dialog interface can identify a target search engine for a corresponding query based on modalities of the interaction data beyond the data represented by the audio signal.

This application claims the benefit of priority to U.S. provisional application having Ser. No. 61/604746 filed Feb. 29, 2012, and U.S. provisional application having Ser. No. 61/711101 filed Oct. 8, 2012.

### FIELD OF THE INVENTION

The field of the invention is human-computer interfaces.

### BACKGROUND

As mobile computing technology becomes more ever-present in our daily lives, mobile device users become more and more reliant on functionality provided by their mobile devices. Ideally, mobile devices, or other computing devices, should allow users to perform queries in a natural and efficient manner. Currently, queries pose difficulties for users that arise from the fact that the structure of underlying data and the set of query criteria available in the data being searched are not transparent to the user. Efficient translation of the user's needs into a successful query requires knowledge of properties of the data being searched and the required format for the query, neither of which is currently obvious from the user's perspective. Users also need a method for refining under-constrained queries when relevant criteria and properties are not obvious. Particularly for mobile devices, approaches using graphical display only are problematic due to limited interactivity and limited screen real estate. Solving this problem requires an interface that is natural for the user while producing validly formatted search queries that are sensitive to the structure of the data, and that gives the user an easy and natural method for identifying and modifying search criteria. Ideally, such a system should select an appropriate search engine and tailor its queries based upon the indexing system used by the search engine. Possessing this ability would allow more efficient, accurate and seamless retrieval of appropriate information. Existing systems and methods fail to support the ability to map cross modal input signals to proposed search criteria, select an appropriate search engine or data source and formulate or structure the search query in a manner based on the indexing system of the search engine or data source.

US patent 2010/0223562 to Sean Peter Carapella et al. titled “Graphical User Interface for Search Request Management” filed Feb. 27, 2009 describes prior work on graphical interfaces for search. The prior work fails to provide natural language or multimodal input to faceted search, dialogue interaction for refining or changing queries or display with click or tap access to search terms.

Efforts directed to the translation of user input into queries for semi-structured data include U.S. Pat. No. 6,282,537 to Stuart E. Macknick and Michael D. Siegel titled “Query and Retrieving Semi-structured Data from Heterogeneous Sources by Translating Structured Queries”, filed Apr. 6, 1999. This prior work in this area fails to address the problem of exposing the underlying structure of the data to the user, providing a seamless and natural interface and enabling the user to refine or alter criteria in a faceted search through multi-modal input.

International application WO 2012/030514 to Wang et al. titled “Sketch-Based Image Search”, filed Aug. 31, 2010, describes using points on a curve of a sketched input as a query. A sketch-based image search thus uses the qualities of the sketched curve to find images that share the same or similar qualities. The search method may include receiving a query curve as a sketch query input and identifying a first plurality of oriented points based on the query curve. The first plurality of oriented points may be used to locate at least one image having a curve that includes a second plurality of oriented points that match at least some of the first plurality of oriented points. Implementations also include indexing a plurality of images by identifying at least one curve in each image and generating an index comprising a plurality of oriented points as index entries. The index entries are associated with the plurality of images based on corresponding oriented points in the identified curves in the images. This work focuses on search based on the characteristics of the object or image being searched. The work additionally describes the indexing of search items based on their characteristics for purposes of efficient search. The work fails to address the cross modality mapping of input signals. The work fails to create an instantiated query interpretation having possible alternative values. The work fails to address the identification of a search engine based on the indexing system of the search engine.

U.S. Pat. No. 7,949,529 to Weider et al. titled “Mobile Systems and Method of Supporting Natural Language Human-Machine Interactions”, filed Aug. 29, 2005, describes speech and non-speech based interfaces that organize domain specific information into agents. A mobile system is provided that includes speech-based and non-speech-based interfaces for telematics applications. The mobile system identifies and uses context, prior information, domain knowledge, and user specific profile data to achieve a natural environment for users that submit requests and/or commands in multiple domains. The disclosed techniques creates, stores and uses extensive personal profile information for each user, thereby improving the reliability of determining the context and presenting the expected results for a particular question or command. Weider may organize domain specific behavior and information into agents that are distributable or updateable over a wide area network. Weider discusses that a system can interpret a user utterance as a query. However, Weider lacks disclosure directed to targeting an indexing system of a search engine.

U.S. Pat. No. 8,346,563 to Hjelm et al. titled “System and Method for Delivering Advanced Natural Language Interaction Applications”, filed Aug. 2, 2012, describes interpreting a request using a plurality of language recognition rules. The system delivers advanced natural language interaction applications, and is comprised of a dialog interface module, a natural language interaction engine, a solution data repository component operating comprising at least one domain model, at least one language model, and a plurality of flow elements and rules for managing interactions with users, and an interface software module. When a request from a user via a network is received, the dialog interface module preprocesses the request and transmits it to the natural language interaction engine. The natural language interaction engine interprets the request using a plurality of language recognition rules stored in the solution data repository, and based at least determined semantic meaning or user intent, the natural language interaction engine forms an appropriate response and delivers the response to the user via the dialog module, or takes an appropriate action based on the request. Hjelm makes further efforts in handling multimodality input. However, Hjelm also lacks insight into translating an interpreted query according to an indexing system.

U.S. patent application 2006/0123358 to Lee et al. titled “Method and System for Generating Input Grammars for Multi-Modal Dialog Systems”, filed Dec. 3, 2004, describes a system with a plurality of modality recognizers where a query generation modules processes an interpretation and retrieves information. A method for operating a multi-modal dialog system is provided. The multi-modal dialog system comprises a plurality of modality recognizers, a dialog manager, and a grammar generator. The method interprets a current context of a dialog. A template is generated, based on the current context of the dialog and a task model. Further, current modality capability information is obtained. Finally, a multi-modal grammar is generated based on the template and the current modality capability information. This reference seeks to address the processing of multimodal input but lacks insight into translating an interpreted query according to an indexing system as well.

U.S. patent application 2012/0109858 to Makadia et al. titled “Search with Joint Image-Audio Queries”, filed Oct. 28, 2010, describes receiving a joint image-audio query from a device and using a joint image-audio relevance model to score resources that are associated with a resource address or indexed in a database. The system includes computer programs encoded on a computer storage medium, for processing joint image-audio queries. In one aspect, a method includes receiving, from a client device, a joint image-audio query including query image data and query audio data. Query image feature data is determined from the query image data. Query audio feature data is determined from the audio data. The query image feature data and the query audio feature data are provided to a joint image-audio relevance model trained to generate relevance scores for a plurality of resources, each resource including resource image data defining a resource image for the resource and text data defining resource text for the resource. Each relevance score is a measure of the relevance of corresponding resource to the joint image-audio query. Data defining search results indicating the order of the resources is provided to the client device. The work focuses on the processing of cross modality input combining audio and image data. Makadia also addresses the issue of using a joint image audio relevance model to score resources to determine their association with resource addresses or indexed in a database. The work also describes the use of more than one source modality in determining the rankings of candidate responses. The material cited however fails to describe the use of the second source modality in a method that proposes alternative values.

Other efforts describe use of multimodal input in a search process. Specifically, U.S. patent application 2009/0287626 to Paek et al. titled “Multi-Modal Query Generation”, filed Aug. 28, 2008, discloses a multi-modal search system that employs text, speech, touch, and gesture input to establish a search query. Additionally, a sub set of the modalities can be used to obtain search results based upon exact or approximate matches to a search result. For example, wildcards, which can either be triggered by the user or inferred by the system, can be employed in the search. Although Paek discusses using regular expressions and wild cards to retrieve indexed information, Paek fails to appreciate that the input modalities can be used to identify a database having a suitable indexing system.

US Publication Number 2013/0036137 A1 to Joseph Ollis et al. titled “Creating and editing user search queries” filed Aug. 5, 2011 describes creating and modifying search queries. The work describes a process by which a query can be constructed by allowing a user to select from categories, facets, or facet values to provide additional or more complete information to a specified query. The systems and methods can allow a user to construct a search query using a reduced number of user input actions while still providing a user with the flexibility to enter any search terms desired by the user. Ollis et al. however fail to address the cross modality mapping of input signals. The work fails to create an instantiated query interpretation having possible alternative values. The work fails to address the identification of a search engine based on the indexing system of the search engine.

US Publication Number 2012/0117051 A1 to Jiyang Liu et al. titled “Multi-modal Approach to Search Query Input” filed Nov. 5, 2010 describes search queries containing multiple modes of query input which are used to identify responsive results. The search queries can be composed of combinations of keyword or text input, image input, video input, audio input, or other modes of input. The multiple modes of query input can be present in an initial search request, or an initial request containing a single type of query input can be supplemented with a second type of input. In addition to providing responsive results, in some embodiments additional query refinements or suggestions can be made based on the content of the query or the initially responsive results. Jiyang Liu et al. focus on the interactive refinement of multi-modal based search queries but fails to create an instantiated query interpretation having possible alternative values. The work fails to address the identification of a search engine based on the indexing system of the search engine.

In U.S. Pat. No. 7,685,116 to Mike Pell, et al. titled “Transparent search query processing”, filed Mar. 29, 2007, a method and system for transparently processing a search query by displaying a search query interpretation or restatement inside a search box is described. When it receives a natural language input from a user, the method converts the natural language input to a search query interpretation of the natural language input and subsequently displays the search query interpretation to the user inside a search box, executes a search based on the search query interpretation and displays a search result to the user. The system includes a user interface to receive a search query input from a user, a restatement engine to convert the search query input into a search query interpretation, a search box to display the search query interpretation to the user, and an execution engine to execute a search based on the search query interpretation and provide a search result for display to the user. Pell et al. primarily concerns formulating and refining speech based search queries from users but fails to address the identification of a search engine based on the indexing system of the search engine.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for a natural multimodal interface for faceted search that interacts with the user to refine the search through multi-turn interactions and exposes the underlying structure of and relevant criteria in the data source to the user in a transparent way.

### SUMMARY OF THE INVENTION

The inventive subject matter provides apparatus, systems and methods that together comprise a multimodal dialog interface in which one can speak naturally and use other input modalities to perform a faceted search. Faceted search provides the ability to submit a query with several search terms, representing different facets within the data and refine or alter the search, possibly iteratively, based on criteria associated with those facets. The described interface preferably communicatively couples with database or other data source over a network (e.g., LAN, WAN, Internet, etc.). One aspect of the inventive subject matter includes a search interface comprising an electronic device (e.g., cell phone, tablet, phablet, game console, etc.) and a dialog interface module. The electronic device can include one or more interfaces capable of receiving multi-modal signals representing user interaction among the device, user, and environment. Preferred multi-modal signals include audio signatures that can represent a spoken utterance of the user. The dialog interface module can be disposed within the electronic device can be configured to aid in generating queries. For example, the dialog interface module can obtain signals, including the audio signal and another signal of a different modality, from the interfaces of the electronic device. The signals can then be mapped to one or more query interpretations by correlating aspects or attributes of the signals to one or more data facets. The interface module can construct a possible set of search criteria that represents the query interpretation where the criteria includes a listing of possible alternative values related to each facet of associated with input signals. The search criteria, along with the alternatives, can be presented to a user of the electronic to allow the user to select clarifying alternative values for the search. Further, the interface module identifies one or more target search engine having an indexing systems or scheme based on the selected value by the user, nature of the multi-modal signals, and the query interpretation. Once a target search engine is identified, the dialog interface module, translates the query interpretation to a target query based on the information available from the multi-modal signals were the target query targets the indexing scheme of a target search engine. In response to the submitting the query to the target search engine, the electronic device can be allowed or enabled to present search results to the user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an illustration of an example mapping from a user mental model to structured data source such as a product hierarchy.

FIG. 2 is an overview of the proposed system.

FIG. 3 provides details on the dialog interface module for mapping an audio signal to an interpretation query.

FIG. 4 shows an example of a drop down menu of query variable alternative values activated by tapping or clicking on highlighted language.

FIG. 5 show another example of presented alternative values which are ranked by recognition likelihood to resolve confusion errors of the recognizer.

FIG. 6 illustrates a method of conducting a faceted search from multi-modal input signals.

FIG. 7 illustrates an example use case.

### DETAILED DESCRIPTION

It should be noted that while the following description is drawn to a computer/server based multimodal interface systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including a natural language and multimodal interface for faceted search that interacts with the user to refine the search through multi-turn interactions and exposes the underlying structure of and relevant criteria in the data source to the user in a transparent way through a drop down menu activate by tapping or clicking on search term language.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. With the context of this document, “coupled with” and “coupled to” are also considered to mean “communicatively coupled with” over a network, possibly through one or more intermediary devices.

The inventive subject matter comprises of an ecosystem comprising a computing device, preferably a mobile device, including but not limited to a smart phone, a tablet, a computer, an appliance, a consumer electronic device, or a vehicle. The device processes spoken input signals and multiple other modalities of input signals from a user and allows the user to initiate and refine, through spoken dialog interaction with the device, a faceted search. Modalities include but are not limited to human speech, text, visual data, kinesthetic data, auditory data, taste data, ambient data, tactile data, haptic data, location data, or other types of data. The faceted search multi-modal natural language interface provides more intuitive interaction for users performing queries or searches, by translating the user's language into valid queries, and possibly suggesting criteria that would not be obvious to the user. The described interface processes speech or possibly other modalities, produces an interpretation using natural language understanding techniques including but not limited to concept identification, key word or phrase spotting, parsing, and semantic analysis.

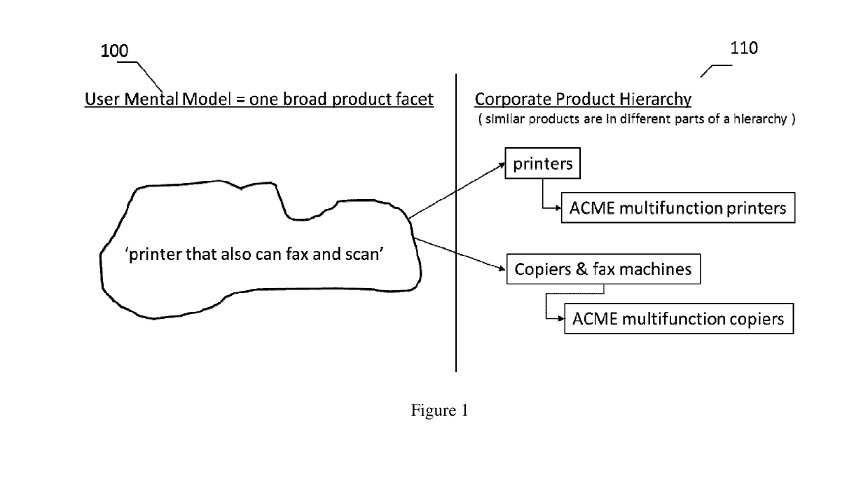

FIG. 1 illustrates the motivation for the system. It depicts an example of data structure that is not obvious to an external the user or consumer. The user is looking for a multifunctional device that includes printing, copying and faxing 100, but would have no indication that they should search in both “copiers and faxes” and in “printers” 110. Similar products can end up in more than one location in a product hierarchy due to historical factors. Other data sources can have similar non-intuitive structure that would be not be obvious, or would be counterintuitive, to the user and would impact on their ability to succeed at their intended search.

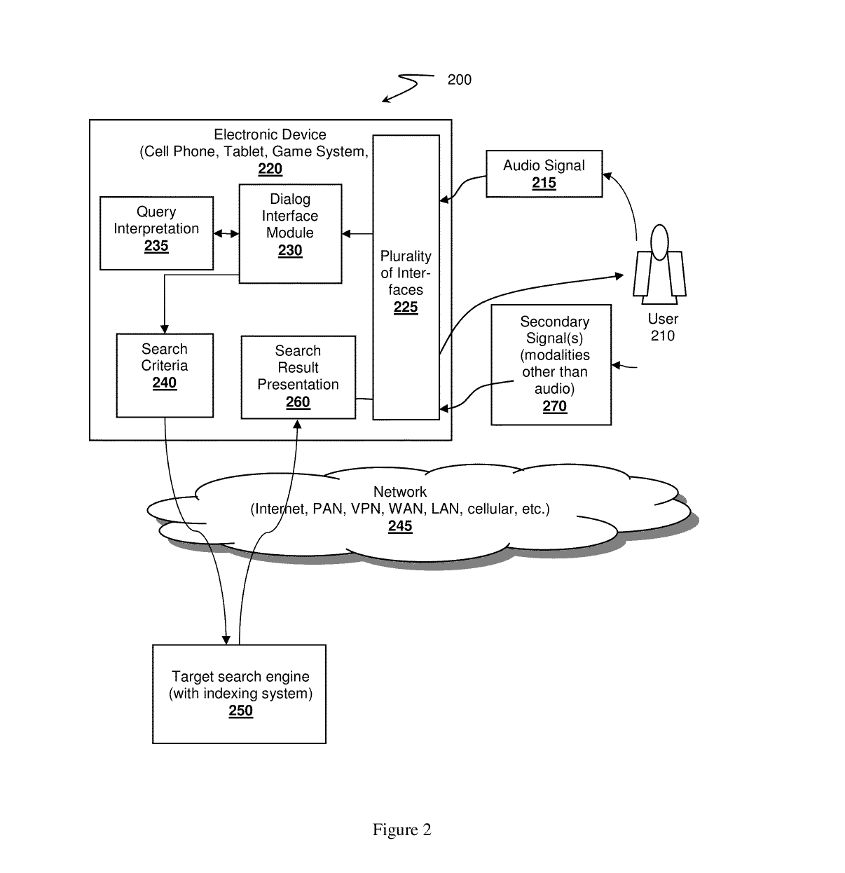

FIG. 2 presents an overview of the system. A user 210 provides an audio signal 215 to the plurality of interfaces 225 on the electronic device 220. The electronic device 220 can be any kind of electronic device that a user might want to communicate with. In other words, it can be a common type of electronic device such as a mobile phone, a tablet, a phablet, a computer, a vehicle. It can also be a set top box for example for television programming (and the television automatically recording based on user preferences). It can be an appliance such as a refrigerator that alerts the user when foods are running out or approaching the expiration date. It can be a home control interface that monitors and updates lighting, heating settings etc. Suitable techniques for home automation can be found in co-owned provisional application having Ser. No. 61/711101, titled “Smart Home Automation Agents” filed Oct. 8, 2012. It can also be a medical device that tracks a user's health statistics, calorie intake, reviews eating and behavior patterns to recommend behavior changes. It can also be a gaming device, a search engine server or a kiosk.

The plurality of interfaces 225 is configured to pass the audio signal 215 on to the dialog interface module 230 which in turn maps the audio signal to a query interpretation 235. Searches can also be refined or adjusted through the dialog interaction module 230. The user can correct or alter a query once the paraphrase is displayed by speaking or using other modalities to communicate a new or corrected query. The dialog interface module then is programmed to create the search query 240 as a function of the audio signal, the second signal and at least one selected value according to the indexing system of the target search engine 250. Next, the targeted query is sent to the target search engine 250 via a network connection 245. Lastly, the query results 260 are formatted by the system according to device constraints and human legibility and presented to the user. When results from submitting the query to the data source are returned, the interface is able to engage in multimodal dialogue with the user about the results which enables the user to change or refine the search. The user can then respond with the secondary signal 270. This secondary signal can comprise of a haptic interaction, an image or one of many other modalities such as a representation of a monition, location, time, biometrics, intonation, inflection, account, gestures, text, taste, hardware status or proximity.

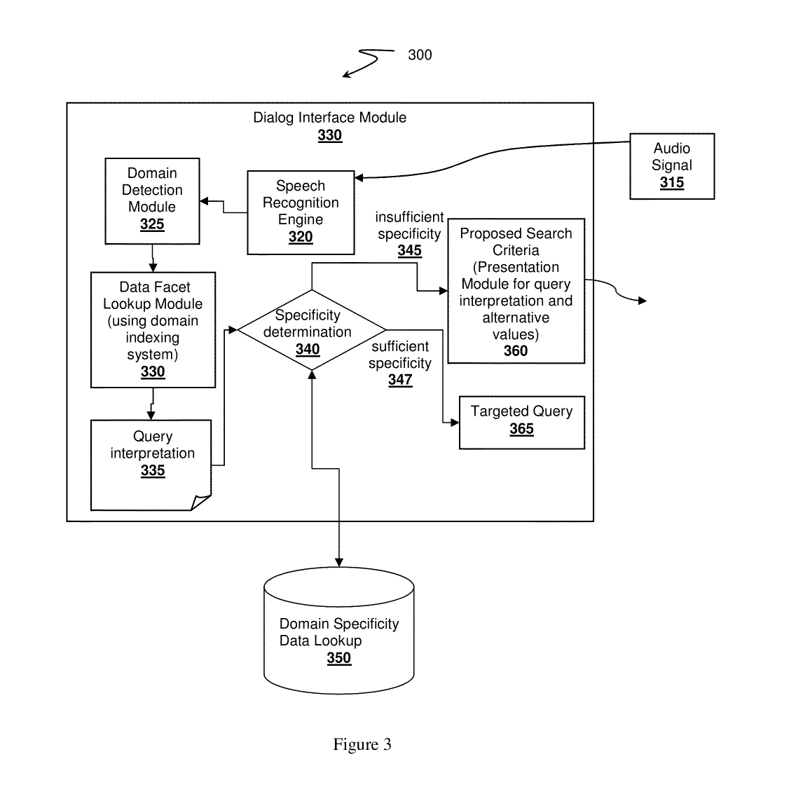

FIG. 3 shows in more detail how a system 300 with dialog interface module 330 is configured. The audio signal 315 is analyzed by the speech recognition engine 320 and maps to a recognition hypothesis. The speech recognition engine 320 utilizes the target search engine and its associated indexing system as well data descriptions such as, for example product listings, to produce a language model, a set of class tags, and an analysis of the structure of the data from the target domain. The language model is then used for speech recognition in order to optimize the recognition accuracy for the given domain.

The domain specific class tags are used for language understanding in the data facet lookup module 330 as discussed below. The recognition result string is sent to a domain detection module 325 which for example can be configured to be a statistical classifier. Once the target domain has been identified both the target domain information and the result string are passed to the data facet lookup module 330. A data facet describes common search options that are appropriate for the current domain. For example, in the clothing domain, size, color, material are such data facet. Additionally, for the inventive subject matter discussed here, the definition of data facet is extended to cover input modality related facets. That is modality itself is an additional facet, speech recognition N-Best results or frequency statistics can all be data facets as well. This data facet lookup 330 uses an indexing system that maps to the target domain search system. The indexing system, which could be based on an ontology or other hierarchical representation, list, relational database, catalog, or other structured data, is used to produce the mapping of an interpretation of the user's input onto a valid query for the target search engine. For example a user might say ‘I need a red cashmere cardigan in size 8” which gets mapped to ‘search domain=clothing, clothing type=cardigan, material=cashmere, color=red, size=8’. Data facets are defined as a hybrid of a classical data categorization where each item is assigned a unique location in a tree or a classification of each item to one out of N classes that are parallel to each other. Data facets are a hybrid of these two because data can both be part of a tree but can appear in multiple classes or tree location due to ambiguity. The data facet lookup 330 can be programmed as a data facet tagger which assigns the matching data facets to the result string. Since human utterances can be ambiguous, see also FIG. 1, multiple sets of data facets can be assigned to a result string. The data structure that includes the target domain and matched data facets now represents the query interpretation 335. This data structure can be seen as a meaning invariant unit that represents the meaning encapsulated in the audio signal 315.

In the next step, “specificity” determination 340, the query interpretation 335 is being evaluated with the help of a “specificity” function. “Specificity” is defined as ‘having enough information to make a decision’. This function in essence determines whether the query representation 335 is specific enough to perform a query against the target search engine whether additional information is required from the user. The “specificity” determination 340 comprises of a threshold function that will vary by target domain and system purpose. For example, in the case of a system for capturing what a user has eaten for a meal, the threshold function will be a domain specificity data facet lookup 350 that checks whether the provided food types and quantities are specific enough to calculate a calorie count. If the current query interpretation 335 has sufficient specificity 347, the targeted query 365 can be assembled. If the query interpretation 335 has insufficient specificity 345, then the presentation module 360 has to assemble a presentation of the proposed search criteria to the user comprising of the current query interpretation 335 and a list of alternative values. A paraphrase of the user's input based on the interpretation is then displayed on the device, so that the user can increased the ‘specificity’ of the query with a second signal in a different modality such as touch or swiping.

The proposed search criteria can be presented using a number of modalities, such as audio data, or visual characteristics according to the data facets. Taking search query variables to as representing search terms or criteria in the data source, in the displayed interpretation, natural language that represents search query variables is displayed in a distinct manner from other language in the displayed paraphrase, and each such item of language has a display property that makes it distinct from other such items. In one embodiment, each instance of language representing a search term or criteria would be in a distinct color. Highlighting the language that represents query variables in the display communicates to the user which material can be altered in the search. In the described interface, clicking or tapping on the highlighted language displays a drop down menu of alternative values from which the user can select using any modality such as speaking, typing, scrolling or tapping.

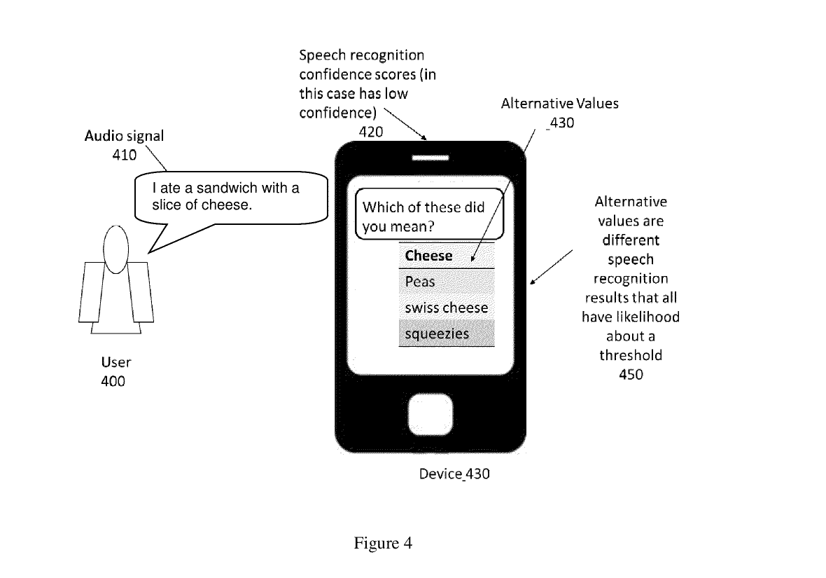

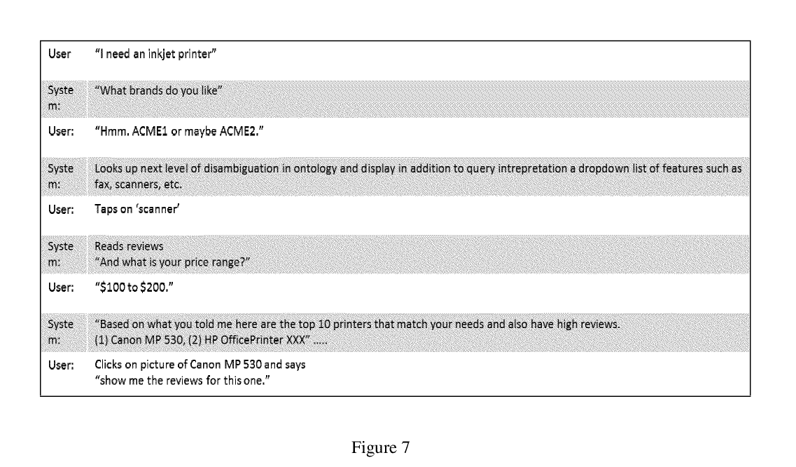

FIG. 4 illustrates the details of how the audio signal 410 from the user 400 regarding a flight search is processed. In this example the query interpretation paraphrase 415 is ‘Searching for airline tickets from San Francisco to Chicago leaving on December 12th’. This query interpretation paraphrase is displayed on the device 430. As the secondary signal 450 the user 400 touches the highlighted item in the query interpretation 415 and the list of alternative values 430 is being displayed. In this example, the highlighting is achieved with a bolded and underlined font. When the user taps ‘Chicago’ the pop-up window with alternative destination cities is displayed. The user could, for example, say ‘Boston’ or tap on ‘Boston’ to change the destination value in the query. The alternative values can be ranked in many different ways, for this example the ranking might be based on proximity to the current destination airport. The ranking after there have been at least two inputs from different modalities by the user can then be based on the nature of the second signal that is its modality, frequency of use etc. For example, if the second modality is haptic, then alternative values that relate to kinesthetic interactions can be raised to the top. If the second modality is gesture (e.g., motion data), the alternative values that correspond to the direction of motion could be ranked close. For example, if a user says “I need a taxi over there” and motion toward a direction, the taxi services the service that direction can be listed. This has the advantage of taking the user preferences into account and thus personalizing the ranking to the user. Another ranking approach that similarly accounts for the user's preferences would be based on prior search frequencies. Yet another ranking mechanism would be to rank according to an ontology based on data facets, according to a structured product listing, a catalog or a diagnostic hierarchy. For example, in a clothing catalog new products are often arranged according to a theme, like ‘spring is here’ and thus when calculating alternative values for a blouse from that theme using a catalog based ranking, the blouses of the same themes would get a high priority. Another example, this time of ranking based on a product ontology is shown in FIG. 7. In this example printers have high level categories like inkjet printer, multifunction printer etc then have smaller categories like product families which might contain all inkjet printer of a printer family which only vary in terms of minor features and price. Yet another example would be a self-guided symptom interpretation system that asks the user a series of question regarding their symptoms and uses a medical diagnostic hierarchy to rank the alternative values for follow-on questions.

The preferred embodiment of the dialog interface uses interaction guides where the interaction guides instruct electronic devices on how to participate within the interaction. Interaction guide structures include but are not limited to general dialogue capabilities such as automated decision making on error handling, and multi-modal interaction, as well as domain dependent dialog interaction behaviors. The domain dependent knowledge is encoded in form of data elements that are associated with an interaction guide. These data elements get filled via user inputs, inference rules, preferences and data elements from other interaction guides. The domain dependent dialog interaction behaviors are encoded in form of actions. Each of these actions contains a trigger rule. Each time a user input needs to be processed; the trigger rules of all of the system actions of the current domain are being evaluated. These trigger rules are such that they include the modality of the user input into their logic. The system action that evaluates to true, is then executed. In the example of the faceted search described here, the most common system action would be the evaluation of the current queries specificity (see also FIG. 3).

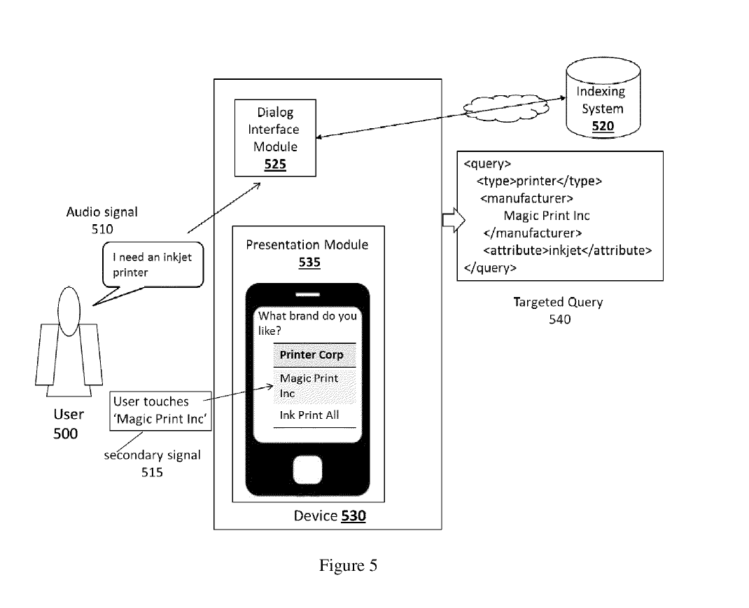

FIG. 5 provides an example of an alternative ranking method for the ordered display of alternative values based on speech recognition confidence scores and sound confusability. The user 500 speaks an audio signal 510 that is being processed by the speech recognition engine which returns confidence scores for all top N recognition hypotheses 520. In this example it is assumed that the overall confidence of the hypothesis is below a predefined threshold and that the presentation module is configured to utilize a confidence-score based ranking formula for the calculation of the alternative values 530. This has the effect that the alternative value list can include items that conceptually have nothing to do with each other, i.e. they do share a conceptual data facet, but they do share the data facet of being alternative recognition hypothesis. The ranked alternative values 530 are then being displayed on the device 520.

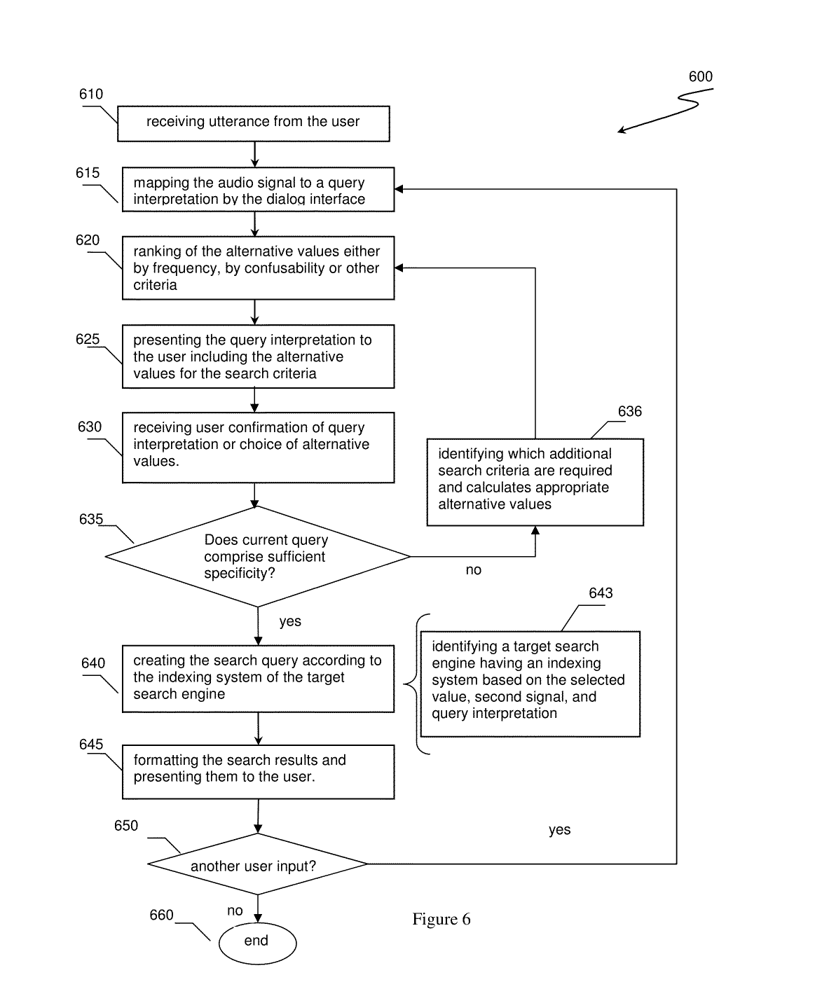

FIG. 6 provides an illustration of the method discussed here. An interaction starts with the user producing an audio signal that contains the search request at step 610 using natural language. The dialog interface then maps this signal to a query interpretation at step 615 as described in detail in FIG. 3. Once the query interpretation has been determined, the alternative values are being looked up and ranked by the currently set ranking criteria at step 620. A number of different ranking criteria can be used as well as a combination of several ranking criteria. One example ranking criteria is illustrated in FIG. 5. Other possible ranking criteria can be proximity to a location, frequency of use, size etc. Step 625 includes presenting the list of alternative values to the user, who in turn can confirm the current query interpretation or choose one of the alternative values at step 630. Upon the selection of an alternative value, the query interpretation is updated and evaluated by the system for ‘specificity’ 635. If the system determines that additional search criteria are required, alternative values are calculated at step 636 and the process returns to step 620.

If the current interpretation query meets the specificity criteria, the search query for the target search engine will be created at step 640. The search query criteria creation comprises of looking up in the current interaction guide, identifying a target search engine (e.g., based on the selected values, signal modalities, query interpretation, etc.) to use for the current domain, possibly based on or as a function of the modality of a second signal other than the audio signal of the utterance. The definition of the search engine to be used is defined via a data element in the domain dependent interaction guide. Once the search engine has been identified, yet another data element in the same interaction guide will specify the identifier for format of the indexing system for the target search engine. Example formats might be a XML versus a SQL database format versus a web API interface versus a REST API. In addition to format differences, each target search also has a known set of query types and data facets that it will understand if written in the correct format. The custom knowledge for each search engine with regard to format and query content is encoded in a search engine specific function. In essence such function encompasses the indexing system of a search engine. The format identifier in the interaction guide maps to such a function. When the interaction guide has determined that the search query needs to be created, the interaction guide will call the identified function and pass it as input arguments the requested data facets (which were encoded via data elements in the interaction guide). The function will then return the assembled query ready to be sent over a network against the search engine in question. Note that there will be data facets that the system discussed here can understand but which are not being understood by the search engine.

In that case, the raw results from the search engine will be post-processed by those data facets that are associated with the target search engine but that do not exist in the indexing system of the target search engine but do show as value in the results. For example when searching a travel search engine for flights, the search engine might not have a query field for specifying the lay-over airport but post-processing can remove itineraries that do not contain the required lay-over airport. This post-processing is particularly powerful because it allows utilizing non-standard data facets such as modalities-used, frequencies or user preferences.

Once the post-processing is complete, the final results will be formatted and presented to the user for review at step 645. The formatting will take into account the modalities of the user input. For example if a user spoke his initial query and then touched to select an alternative value from a drop-down list, then the result presentation would also be a mix of reading out a short summary and displaying details on the screen. However, if a user only used voice and larger body motion to provide input than the output will focus on including all important information in the voice output even if that might take longer. Or if the device determines that the user is driving based on the change of GPS location, the output might also be only voice even if it has the disadvantage of being more time-consuming.

If the user provides a new signal because she decides to change the search criteria or wants to refine them, the process returns to step 615. If there is no additional user signal, the process ends at step 660.

The interface may suggest additional criteria to the user based on information in the data source as in FIG. 7 in which the system suggests the “fax” and “scanner” properties as additional potential search criteria for the user's query for a printer. The envisioned dialogue interface is flexible allowing the user to follow the system's suggestions or request other search criteria and with the system on refining the search through multiple turns. Note that the manner in how the additional search criteria are being presented is made to be a function of the modalities used in the same manner as described in the above paragraphs.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A search interface comprising:
an electronic device comprising a plurality of interfaces, the interfaces collectively capable of receiving multimodal input including audio signals; and
a dialog interface module disposed within the electronic device and configured to:
obtain an audio signal representing audio data of a spoken utterance from the plurality of interfaces;
obtain a second signal representing a modality other than audio data from the plurality of interfaces;
map the audio signal and second signal to a query interpretation by correlating audio signal and second signal to a plurality of data facets;
construct proposed search criteria representing the query interpretation and including alternative values for each data facet of the plurality of data facets;
present the proposed search criteria, including the alternative values, to a user via the electronic device;
receive at least one selected value from the presented alternative values;
identify a targeted search engine having an indexing system based on the at least one selected value, the second signal, and the query interpretation;
translate the query interpretation to a targeted query as a function the audio signal, second signal, and the at least one selected value, the targeted query constructed according to an indexing system of the target search engine;
cause the targeted query to be submitted to the target search engine; and
enable the electronic device to present search results from the target search engine response to submission of the targeted query.

2. The interface of claim 1, wherein the second signal comprises a representation of a haptic interaction.

3. The interface of claim 1, wherein the second signal comprises a representation of an image.

4. The interface of claim 1, wherein the second signal comprises a representation of at least one of the following: motion, location, time, biometrics, intonation, inflection, accent, gestures, text, taste, hardware status and proximity.

5. The interface of claim 1, wherein the electronic device comprises at least one of the following: a phone, a tablet, a set top box, an appliance, a gaming device, a computer, a medical device, a search engine server, a vehicle, a home control interface and a kiosk.

6. The interface of claim 1, wherein the dialog interface is further configured to present the targeted query to the user via the electronic device.

7. The interface of claim 6, wherein the electronic device is configured to present the proposed search criteria according to the modality of the second signal.

8. The interface of claim 6, wherein the electronic device is configured to present the proposed search criteria as audio data.

9. The interface of claim 6, wherein the electronic device is configured to present the proposed search criteria using different visual characteristics according to the data facets.

10. The interface of claim 9, wherein the visual characteristics include at least one of the following: a color, a font size, a font, a font modality such as underlined, an intensity, a timed pattern, a shape, a pattern, an image, an animation and an icon.

11. The interface of claim 1, wherein the dialog interface is further configured to rank the alternative values of the proposed search criteria.

12. The interface of claim 11, wherein the alternative values are ranked according to a type of modality of the second signal.

13. The interface of claim 11, wherein the alternative values are ranked according to frequency of previous searches.

14. The interface of claim 11, wherein the alternative values are ranked according to an ontology representing the data facets.

15. The interface of claim 11, wherein the alternative values are ranked according to a structured product listing.

16. The interface of claim 11, wherein the alternative values are ranked according to a catalog.

17. The interface of claim 11, wherein the alternative values are ranked according to a diagnostic hierarchy.

18. The interface of claim 1, wherein the dialog interface module is further configured to identify the target search engine based on a modality of the second signal.

19. The interface of claim 18, wherein the target search engine is identified based on the indexing system being compatible with the modality of the second signal.
